(19) United States
(12) Patent Application Publication
(10) Pub. No.: US 2012/0076927 A1
(43) Pub. Date: Mar. 29, 2012

(54) METHOD OF IMPROVING THE THERMO-MECHANICAL PROPERTIES OF FIBER-REINFORCED SILICON CARBIDE MATRIX COMPOSITES

(75) Inventors: Ramakrishna T. Bhatt, North Olmsted, OH (US); James A. Dicarlo, North Olmsted, OH (US)

(73) Assignee: UNITED STATES GOVERNMENT AS REPRESENTED BY THE SECRETARY OF THE ARMY, WASHINGTON, DC (US)

(21) Appl. No.: 13/018,611

(22) Filed: Feb. 1, 2011

Related U.S. Application Data
(60) Provisional application No. 61/300,227, filed on Feb. 1, 2010.

(51) Int. Cl. B05D 5/12; C04B 35/64

(52) U.S. Cl. 427/122; 264/614

(57) ABSTRACT

A thermal treatment process for improving thermo-mechanical properties of ceramic matrix composite materials such as silicon carbide (SiC) matrix composites is described. The treatment process removes excess silicon and/or other process-related defects from the SiC-based matrix as well as the fiber interfacial coating. This invention can be practiced with minimal strength loss for as-fabricated composites formed from high-strength continuous-length ceramic and carbon-based fibers that are functionally stable to 1600° C. and above. The invention provides a method for significantly improving composite thermal conductivity and creep resistance, and for reducing composite porosity. It has been demonstrated using state-of-the-art 2D woven SiC/SiC composites containing Sylramic-iBN SiC fibers, boron-nitride-based interfacial coatings, and hybrid matrices that are based on SIC formed by chemical vapor infiltration (CVI) and by a combination of CNI, SiC particulate infiltration, polymer infiltration and pyrolysis, and melt infiltration of silicon, silicon-based alloys, and silicides.

### RELATED APPLICATIONS

This application claims the benefit of U.S. Provisional Patent Application Ser. No. 61/300,227 filed on Feb. 1, 2010 titled “Method of Improving the Merino-Mechanical Properties of Fiber-Reinforced Silicon Carbide Matrix Composites” which is hereby incorporated by reference in its entirety.

### GOVERNMENT INTEREST

The invention described herein may be manufactured, used, and licensed by or for the United States Government.

### FIELD OF THE INVENTION

This invention relates generally to methods of treating composite materials and to treated composite materials. In specific embodiments, the invention relates to methods of treating ceramic matrix composite materials, such as silicon carbide and to treated silicon carbide materials that can be used to make various products and components including, but not limited to, inner turbine ducts, flame holders, combustor liners, turbine components such as nozzle vanes and blades for land based and aero engines, divergent and convergent flaps for military aircrafts, containment vessels for nuclear reactors, rocket components and so forth.

### BACKGROUND OF THE INVENTION

The realization of improved efficiency for engines used for aero and space propulsion as well as for land-based power generation will depend strongly on advancements made in the upper use temperature and life capability of the structural materials used for the engine hot-section components. Components with improved thermal capability and longer life between maintenance cycles will allow improved system performance by reducing cooling requirements and life-cycle costs. This in turn is expected to reduce fuel consumption, NOₓ and CO₂ emissions, ticket cost, and flight times for commercial aircraft; to allow improved thrust-to-weight and performance for space and military aircraft; and to reduce emissions and power costs for the electrical power industry.

Today the major thrust in the United States, Japan, and Europe for achieving these benefits is by the development of fiber-reinforced ceramic matrix composites (CMC) in general and fiber-reinforced silicon-carbide (SiC) matrix composites in particular. These materials are not only lighter and capable of higher use temperatures than state-of-the-art metallic alloys and oxide matrix composites (˜1100° C.), but also capable of providing significantly better static and dynamic toughness than un-reinforced silicon-based monolithic ceramics. However, for successful application in advanced engine systems, the SiC matrix composites should be able to withstand the component service stresses and temperatures for the desired component lifetime. Since the high-temperature structural life of ceramic materials is typically controlled by creep-induced flaw growth, a key composite property requirement is the capability for displaying high creep resistance under these conditions. Also, because of possibility of severe thermal gradients in the components, the composites should provide the uppermost in thermal conductivity in order to minimize the development of thermal stresses that can add to the mechanical and aerodynamic stresses that induce creep and reduce component life.

Theory and experiment show that for fiber-reinforced SiC matrix composites, the key thermo-mechanical property requirements of high creep resistance and high thermal conductivity are primarily controlled by the SiC matrix. Thus, one of the major technical challenges for implementation of SiC matrix composites in engine hot-section components is to develop SiC matrices that can provide the uppermost in these properties after component fabrication and during component engine service.

Currently, the manufacturing of state-of-the-art SiC-matrix composite products typically begins by the use of textile processes (weaving, braiding) to form multi-fiber bundles or tows of ceramic fibers into 2D and 3D fiber architectures or preforms that meet product size and shape requirements. For assuring crack deflection between the fibers and final matrix, a thin fiber coating or interphase material with a mechanically weak microstructure, such as boron nitride (BN) or pyrolytic carbon is then applied to the fiber surfaces by chemically vapor infiltration (CVI). SiC-based matrices are then formed within the coated preforms by four primary processes and their combinations: (1) CVI of precursor carbon and silicon-containing gases that react on the preform surfaces to leave a dense SiC product; (2) non-reactive forming (NRF) by SiC particulate infiltration followed by infiltration of molten silicon, silicon alloys, or silicides, (3) reactive forming (RF) between molten silicon and pre-infiltrated porous solid carbon matrices; and (4) polymer infiltration and pyrolysis (PIP) in which a pre-ceramic SiC-forming polymer is repeatedly infiltrated into open porosity remaining in the composite preform and then pyrolyzed by high-temperature thermal treatments. Some of these conventional processes can sometimes be combined with each other to form hybrid SiC based matrices. Also, as a final step, any remaining open porosity in the ceramic matrices can be filled by the high-temperature process of melt infiltration of metals, such as silicon, silicides such as titanium silicide into the matrix pores.

Generally one of the highest performing SiC-matrix composites is fabricated by the CVI SiC matrix process. In contrast to the NRF and RF-formed SiC matrices, which tend to be thermally unstable due to local areas of excess carbon or excess silicon, and in contrast to the PIP-formed SiC matrices, which tend to be micro-cracked, the CVI-formed SiC matrices are more thermally stable and denser. As such, they are able to provide better environmental protection to the interphase-coated SiC fibers, plus provide the composite with better resistance to crack propagation. Also the denser CVI SiC matrix has the potential for providing optimal thermal conductivity and creep resistance to the composite. However, for two major reasons, this potential is not currently being achieved in composites with SiC matrices that have CVI SiC as a prime constituent.

First, when the CVI SiC matrix process is taken to completion (full CVI SiC matrices), a considerable volume fraction of trapped or closed porosity is left in the composite (about 10 to 15%), which is created when the CVI process is used to fill the large interstices between tows in the fiber preforms. This in turn results in a composite thermal conductivity significantly below that expected for a matrix with about 0% porosity. Second, for best infiltration into the textile-formed fiber tows, the CVI SiC matrix process (as well as the CVI interphase process) typically has to be conducted at a temperature below 1100° C., which is well below the application temperatures where the ceramic composites could have their greatest practical benefits. Under these processing conditions, although the SiC matrix is fairly dense, its microstructure typically contains meta-stable atomic defects and is non-stoichiometric due to a small amount of excess silicon. These defects typically exist at the matrix grain boundaries where they can act as scatterers for thermal phonons and enhance matrix creep by grain-boundary sliding, thereby not allowing the composite to display optimal thermal conductivity and creep resistance.

To address the first issue, state-of-the-art ceramic composites today are still employing the CVI SiC process, but are stopping the process before the trapped matrix porosity becomes too large. The remaining open porosity within the partially completed matrix is then infiltrated with high-conductivity additives, such as by melt-infiltration of silicon metal near 1400° C., or by SiC slurry infiltration at room temperature followed by silicon melt-infiltration. This typically yields a final composite with about 5% closed porosity within the fiber tows and about 0% porosity between the tows. The final composite system (generally referred to as an MI composite) typically displays a thermal conductivity about double that of a full CVI SiC composite system where the CVI matrix process is carried to completion.

Although progress has been made in prior art concerning the minimization of the porosity issue within CVI SiC matrices and its degrading effects on composite performance, no prior art efforts are known to exist that address the second intrinsic issue of structural defects and excess silicon within the CVI SiC matrix microstructure. This issue and its significant detrimental effects on composite thermal conductivity and creep resistance exist in all SiC-based matrices containing CVI SiC, independent of their volume fraction in the final composites. Thus, there is a need for composites with thermal conductivity and creep resistance approaching optimal values and for a method for fabricating such composites.

Further details and advantages of the present invention will be apparent from the drawings, discussion and description which follow.

### SUMMARY OF THE INVENTION

Disclosed herein is a method for improving the thermostructural properties of a ceramic matrix composite material that includes the steps of: (1) providing a ceramic matrix composite material in a completed form or a partially completed form that comprises a plurality of reinforcing fibers, a fiber interface coating, a ceramic containing matrix, where said that reinforcing fibers were produced under process time-temperature conditions greater than those used for the fiber interface coating; and (2) heating said ceramic matrix composite material at a process temperature for a process hold-time under a process gas at a process pressure and a process flow rate. In certain embodiments, the reinforcing fibers include at least twenty percent by volume of silicon carbide. Desirably, the fibers have a high tensile strength that is stable in the process gas environment under a process pressure up to 40 atmospheres for a process hold-time of at least one hour at a process temperature of at least 1600° C. it certain desirable embodiments, the chemical and physical characteristics of the fiber interfacial coating are such as to minimize fiber attack from the ceramic matrix and fiber strength loss during the process treatment. For example, the composition of the fiber interfacial coating may consist of or at least include boron nitride, and/or carbon on top of boron nitride, and/or boron nitride doped with silicon, and/or silicon nitride on top of boron nitride or a combination thereof. Desirably, the process treatment will also improve the fiber interfacial coating by removing porosity and impurities in the coating.

In certain desirable embodiments, the ceramic matrix material is formed by partial or complete infiltration of silicon carbide by chemical vapor infiltration of silicon-carbide yielding gases, or by a first partial infiltration of silicon carbide by chemical vapor infiltration of silicon-carbide yielding gases followed by infiltration of silicon-carbide particulate or by polymer infiltration and pyrolysis of silicon-carbide yielding polymer, or a combination thereof. In certain embodiments, the ceramic matrix composite material is processed at a process temperature of at least 1600° C. for a process hold-time sufficient to remove free silicon and other defects that are contained in the original silicon carbide matrix and/or the interfacial fiber coating. In certain desirable embodiments, the time and temperature conditions are sufficient to reduce the silicon content in the silicon carbide-based matrices so that the silicon to carbon ratio after treatment is less than about 1.005 atoms of silicon to one atom of carbon. The ceramic composite material may be processed in a vacuum, or in a chemically inert gaseous environment, or in a high-purity nitrogen environment, or in a combination thereof. Thus in certain embodiments, the ceramic composite material is processed in a chemically inert gaseous environment that consists essentially of helium, neon, argon, xenon, krypton, radon or a combination thereof. Desirably, the process treatment improves the thermal conductivity of the original ceramic composite material with less than about 10 percent loss in fiber tensile strength and less than about 10 percent loss in composite tensile strength, and in certain embodiments improves the creep resistance of the original ceramic composite material with less than 10 percent loss in fiber and composite tensile strength, in certain embodiments, the process treatment includes a processing temperature between about 1600° C. and about 1800° C. for a processing hold-time of up to 100 hors in vacuum or in an argon gas with a purity greater than about 99% at a pressure no greater than 2 atmospheres and with a flow rate between zero and one cubic-foot/hr. In other embodiments, the ceramic composite material is subjected to a process temperature for a process hold-time within a process gas at a process pressure and process flow rate that a sufficient to produce a thin carbon layer on the silicon-carbide matrix material with less than 10 percent loss in fiber and composite tensile strength. The method may also include an additional step whereby a subsequent final fabrication of the composite matrix by molten silicon and/or silicide infiltration is enhanced, thereby reducing the permeability and improving the density of ceramic composite material. In desirable embodiments that enhance subsequent silicon or silicide infiltration, the process treatment also provides an improved tensile creep resistance and an improved thermal conductivity compared to tensile creep resistance and the thermal conductivity of the original partially-infiltrated ceramic matrix composite material. The process treatment for enhanced silicon or silicide may include a processing temperature between about 1600° C. and about 1800° C. for a processing hold-time of up to 100 hours in vacuum or in an argon gas with a purity greater than 99.999% at a pressure no greater than 2 atmospheres and with a flow rate between zero and one cubic-foot/hr. For example, the process treatment may include processing the ceramic matrix composite material at about 1700° C. for a processing hold-time of at least about one hour in a vacuum or in high-purity argon at a pressure slightly greater than one atmosphere.

In certain embodiments the present invention provides the ability to employ specially designed thermal treatments to significantly improve the matrix infiltration characteristics, microstructure, and stoichiometry of chemical vapor infiltration (CVI) silicon carbide (SiC) matrices in high-performance ceramic composites. These treatments can be performed either prior to or after the infiltration of ceramic fillers into the porosity remaining in the CVI SiC matrix. Pore fillers can include, but are not limited to, ceramic particulate, molten metallic alloys and/or pre-ceramic polymers.

In addition, the present invention also provides improved ceramic matrix composite materials with thermostructural properties that are improved compared to similar untreated material.

### BRIEF DESCRIPTION OF THE DRAWINGS

FIG. 1 is a graph illustrating the relationship between CVI SiC volume percent and ultimate tensile strength for treated and untreated ceramic matrix composite materials;

FIG. 2 is a graph illustrating the room temperature transverse thermal conductivity for two pairs of treated and untreated CVI SiC/SiC composite materials obtained from the two different vendors;

FIG. 3 is a graph illustrating the effect of the treatment on the tensile creep behavior;

FIG. 4 is bar graph illustrating the effect of the treatment on the 25° C. and 1300° C. transverse thermal conductivity of Sylramic-iBN fiber-reinforced SiC/SiC composites with about 28 and 39 vol % CVI SiC matrices whose remaining porosities were filled by silicon alone or by SiC particulate and silicon;

FIG. 5 is a graph illustrating the effect of treatment hold-time on the room-temperature transverse thermal conductivity;

FIG. 6 is a graph illustrating creep behavior of untreated composite materials compared to those treated and tested under the same testing conditions;

FIG. 7 is a graph illustrating creep behavior of untreated composite materials compared to those treated and tested under the same testing conditions;

FIG. 8 is a graph illustrating the effect of treatment on room temperature thermal conductivity of a treated composite compared to a similar untreated composite;

FIG. 9 is a graph illustrating the effect of treatment on the creep behavior of a treated composite compared to a similar untreated composite;

FIG. 10 is a series of computed tomography images taken at different stages of the treatment process of a 20 volume % CVI SiC composite;

FIG. 11 is a series of computed tomography images taken at different stages of the treatment process of a 35 volume % CVI SiC composite;

FIG. 12 is a graph illustrating the effect of treatment on room temperature tensile properties; and

FIG. 13 is a graph illustrating the effect of treatment on room temperature tensile properties.

### DESCRIPTION OF THE PREFERRED EMBODIMENTS

The present invention provides a method of improving thermal conductivity, creep resistance, and/or matrix infiltration characteristics of state-of-the-art fiber-reinforced ceramic matrix composite materials, for example silicon carbide (SiC) matrix composites reinforced by high performance SiC fibers, without significantly affecting their ultimate tensile strength (UTS). The method is generally accomplished by selecting a composite material which is reinforced by a high strength fiber that is functionally stable under temperature conditions to 1600° C. and above, and by modifying the fiber interfacial coating and ceramic matrix by controlled thermal treatment of the composite material after conventional interfacial and ceramic matrix formation processes have been applied. This innovation is in general designed to remove impurities and defects in the coatings and matrices formed by any low temperature process, and in particular to remove excess silicon from those SiC matrices formed by chemical vapor infiltration (CVI) processes. Silicon removal occurs by diffusion to the matrix internal and external surfaces and subsequent evaporation. If the fiber coating and/or treatment conditions are not properly designed, the silicon reaching the fiber coating can attack the fiber and reduce composite ultimate strength. Thus the treatment time-temperature-environmental conditions must be specially designed as revealed in this innovation.

Improvement of fiber-reinforced SiC matrix composites after partial or full SiC matrix formation can be accomplished in a graphite element furnace at temperatures between 1600 and 1900° C. for times up to 100 hrs in a vacuum environment, or in 1 atmosphere or higher pressure of inert gas such as argon or high purity nitrogen gas. Suggested furnace or process temperatures include, but are not limited to, about 1600° C., about 1650° C., about 1700° C., about 1750° C., about 1800° C., about 1850° C. and even about 1900° C. Suggested process hold times include, but are not limited to, at least about one hour, at least about 2 hours, at least about 4 hours, at least about 10 hours, at least about 20 hours, and even as much as up to about 100 hours and process hold-times sufficient to remove free silicon and other defects that are contained in the original ceramic matrix and/or in the interfacial coating. If the objective is to enhance subsequent infiltration of molten silicon, silicon alloys, and/or silicides into the treated matrix of partially formed composite materials, non-reactive environments are preferred avoid the creation of new flaws and the production of detrimental compositions on the SiC matrix external surfaces. For example, although high-purity nitrogen containing environments can be used to improve the composite creep resistance, at temperatures >1500° C. nitrogen will react with SiC, forming a silicon nitride rich surface layer. Then during subsequent melt infiltration of molten metals, the silicon nitride rich surface layer will reduce wet-ability of the molten metals, resulting in a final composite with a substantial amount of internal closed porosity. Also the silicon nitride skin formed on the surfaces of the SiC matrix might substantially reduce thermal conductivity of the final composite. On the other hand, treatment in inert gas or vacuum can be used, if so desired, to form a carbon-rich surface layer on the SiC matrix surfaces because the SiC surface partially dissociates into silicon vapor and carbon. When the silicon vapor leaves, a carbon rich surface layer remains with a thickness that can be controlled by the heat-treatment temperature and time of exposure. This carbon layer significantly enhances wet-ability of molten silicon metal and its alloys favoring fabrication of fully dense melt infiltrated SiC/SiC composites with enhanced thermal conductivity.

For the treatment process, a heating rate between 2 to 10 degrees/min is recommended to avoid thru-thickness thermal gradients. This is particularly important for avoiding delamination between plies of composites formed from 2D fiber architectures. In order to achieve the full benefits of this invention, the treatment temperature and treatment hold-time are selected based on achieving final composites with optimal thermal conductivity and/or creep resistance without significant loss in composite ultimate tensile strength (UTS), which is typically controlled by the stability of the reinforcing fiber. For composites with matrices formed from CVI SiC, these treatment conditions are typically selected as those that cause nearly complete removal of excess silicon from the CVI SiC matrix. During treatment, part of the silicon present in the CVI SiC matrix diffuses outward from the infiltrated tow to matrix external surfaces, where it typically evaporates as silicon vapor, and part of the silicon diffuses inward toward the fiber, where it may react with the interphase coating and fiber, leading to loss in composite UTS. This effect can be minimized by sequential CVI matrix infiltrations, each followed by heat treatments, and/or by engineering the fiber coating such as by depositing a thin carbon or Si₃N₄ layer on top of a compliant oxidation-resistant CVI BN layer before deposition of the CVI SiC matrix. Respectively, these coatings either react with the free silicon or act as a diffusion barrier for free silicon diffusing from out of the CVI SiC matrix, thus maintaining fiber and composite ultimate strength.

Since silicon diffusion is a time-dependent process, the temperature-time schedule for complete removal of silicon depends on several factors, namely open porosity, tortuosity of pores, thickness of CVI SiC matrix on the fiber tows, thickness of composite part itself, and total excess silicon content as produced in the CVI SiC by different composite manufacturers. For example, for given manufacturer, SiC/SiC composites containing about 20 vol % CVI SiC matrix and about 30 vol % open porosity may require 1 h of treatment at 1700° C. to completely remove the excess silicon from the CVI SiC coating; whereas SiC/SiC composites containing about 35 vol % CVI SiC matrix and about 15 vol % open porosity may require nearly 20 h of treatment at the same temperature. When the silicon is completely removed, the CVI SiC matrix reaches a nearly stoichiometric composition; that is, the Si/C ratio within the CVI SiC matrix reaches a value of about 1, for example between 0.99 and 1.01, preferably between 0.999 and 1.001 and still more preferably between 0.9999 and 1.0001. Analytical techniques such as Raman spectroscopy and neutron activation analysis can be used to monitor depletion of silicon from the CVI SiC matrix and to determine its stoichiometry.

By controlling the treatment schedules, this innovation has the advantage of significantly improving the transverse and axial thermal conductivities, density, and creep resistance of state-of-the-art 1D, 2D and 3D SiC/SiC composites with CVI SiC matrices with minimal effect on the ultimate tensile strength of the composites. Suggested fibers include, but are not limited to, fibers that include at least 20 percent by volume and that are based on thermally stable silicon carbide or carbon compositions. Preferably, these fibers should have an as-produced tensile strength of at least 2.5 GPa in order to provide the composite material with high toughness. This innovation can be practiced on any CVI SiC matrix composite system that contains ceramic or carbon-based fibers that are functionally stable to 1600° C., about 1650° C., about 1700° C., about 1750° C., about 1800° C., about 1850° C. and even about 1900° C. and above. The capability of the innovation for significantly improving composite thermal conductivity and creep resistance has been demonstrated using state-of-the-art 2D woven SiC/SiC composites containing Sylramic-iBN SiC fibers, boron-nitride-based interphases, and hybrid matrices that are based on SiC formed by he chemical vapor infiltration (CVI) method. Suggested interphase coatings include, but are not limited to, boron nitride, boron nitride doped with silicon, silicon nitride on top of boron nitride and various combinations thereof. Using this technology durability and reliability of next generation turbine components such as combustor liners, nozzle vanes, blades, inter-turbine ducts, flame holders, seals, divergent and convergent flaps for aircrafts, rocket components, containment vessels for nuclear reactors and so forth can be significantly improved.

### EXAMPLES

The following seven examples illustrate certain aspects and advantages of various embodiments of this invention. These examples all involve SiC/SiC composites produced as 2×150×230 mm panels with total fiber content of about 32-36 percent by volume percent. To fabricate each example panel, 8 plies of 0/90 five harness satin fabric of Sylramic or Sylramic-iBN SiC fibers were stacked in graphite tooling, and then coated with BN fiber-coating material by chemical vapor infiltration (CVI) at a temperature less than 1000° C. These fiber types are high-strength, thermally conductive, small-diameter SiC fibers with the Sylramic-iBN fiber being more creep and rupture resistant and also having a thin in-situ grown BN layer on its surface. The fibers were originally produced above 1700° C. and thus typically retain their as-produced tensile strength of ˜3 GPa during the thermal treatments needed for this invention. Also, although the CVI BN fiber coating was produced at low temperature, the thermal treatments needed for this invention do not alter its key function of allowing matrix cracks to deflect around the fibers.

After CVI BN coating deposition, the coated fabric stacks were infiltrated with CVI SiC matrices at different volume fractions. Each partially completed panel was then cut in half, with one-half being thermally treated to remove defects and excess silicon from the CVI SiC matrices and the other half being un-treated. For Example 1, the remaining porosity in each panel (about 15% to about 35% by volume) was filled by epoxy. Specimens from the half-panels were then tested to demonstrate the capability of this invention to retain ultimate tensile strength after thermal treatment. For Examples 2, 3, 4, and 5, remaining composite porosity for each panel set was filled by various conventional approaches for ceramic matrix infiltration. For Examples 6 and 7, various approaches were employed to minimize Si attack of the fibers when the SiC matrix contains a high content of free silicon. Specimens from these half-panels were then tested to demonstrate the capability of this invention for significantly improving composite thermal conductivity and creep resistance with minimum fiber attack and loss in composite UTS.

Composite thermal conductivity was calculated from specimen density data, and temperature-dependent data for specimen thermal diffusivity and specific heat. Thermal diffusivity was measured by the thermal flash method both in the transverse or through-thickness direction and in the axial or in-plane 0° direction of the specimens. On an absolute basis, the axial conductivity for a given specimen type was always greater than its transverse conductivity due to a reduced effect of the low-conductivity BN interphase. Thus the composite transverse conductivity measurements were more sensitive to the intrinsic matrix conductivity. Tensile strength measurements were made at room temperature, whereas creep measurements were made in air at 1315° C. and 1450° C. using standard ceramic composite testing procedures (ASTM C 1337-96). Tensile stresses were applied in-plane along the 0° fiber direction.

### Example 1

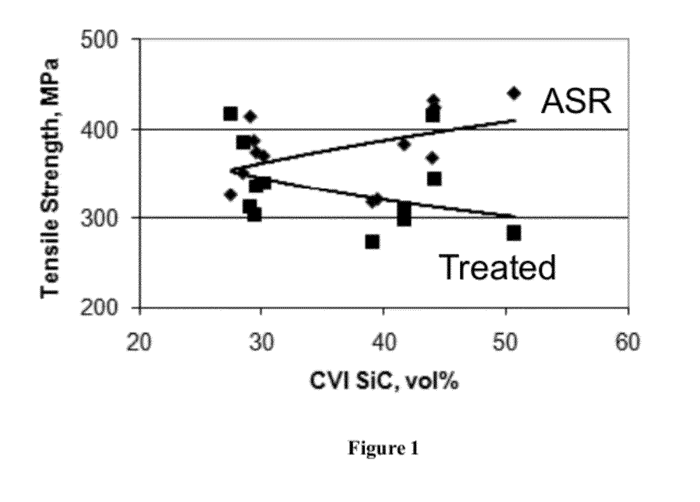

For this case, Sylramic-iBN/BN/SiC panels were fabricated with different fractions of CVI SiC matrix, ranging from about 25 volume percent to about 45 volume percent. Half of each panel was kept in its as-fabricated or as-received condition, and the other half was treated in one atmosphere of argon at 1700° C. Based on prior silicon removal studies, the panels with the lowest SiC content were treated for 1 hr and those with the highest SiC content for 20 hrs. The open porosity in each half-panel was then filled with epoxy, and tensile specimens machined from the panels for strength testing at room temperature. FIG. 1 shows that as the CVI SiC vol % increased in the untreated composites, the as-fabricated ultimate tensile strength of the composites also increased. This effect is not understood, but does not appear serious for the composites with lower SiC fraction because their UTS increased after treatment, approaching that of the untreated higher SiC content composites. However, after treatment, the UTS of the higher SiC content composites measurably decreased. This effect can be explained by a higher amount of excess silicon in the higher SiC content matrices, which can move toward the fibers and eventually react with the CVI BN interphase and finally the Sylramic-iBN SiC fibers. Thus it would appear that practice of this invention with minimal SiC/SiC ultimate strength degradation is best achieved with CVI SiC matrices of less than 30 vol %. For the higher SiC content composites, one might be able to accept a small strength loss (about 30%) or one could develop microstructural approaches that either reduce the silicon in gradual steps or minimize its diffusion towards the fibers.

### Example 2

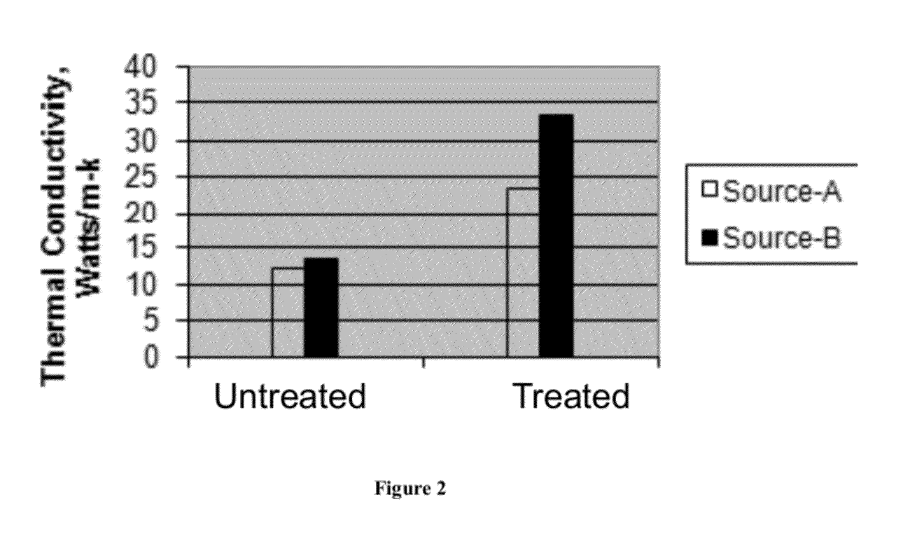

For this case, Sylramic and Sylramic-iBN/BN/SiC panels were fabricated at two CMC vendors with the highest possible volume fraction of CVI SiC. These panels were effectively full CVI SiC matrix composites with a matrix volume fraction of about 50%, a closed porosity of about 10%, and an open porosity of about 0%. One-half of each panel type was treated by the processes of this invention, and then both halves were evaluated in terms of thermal conductivity and creep resistance. The treated panels were treated in one atmosphere of argon at 1800° C. for 1 hour. FIG. 2 shows that after treatment, the room temperature transverse thermal conductivity approximately doubled for both CVI SiC/SiC composite types obtained from the two different vendors. Although not shown, the axial thermal conductivity of these composites after treatment also increased by about 75%. This improvement can be attributed totally to an improvement in the thermal conductivity of the full CVI SiC matrix because the thermal conductivity of the SiC fiber should riot change after treatment.

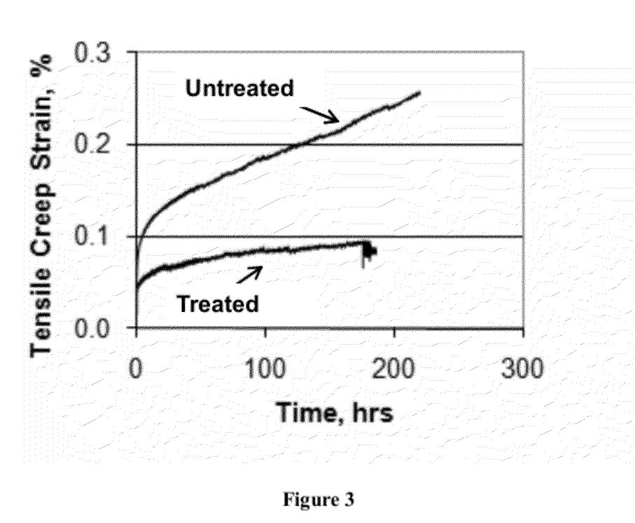

FIG. 3 shows the effect of treatment on the tensile creep behavior for the full CVI Sylramic-iBN/BN/SiC composite as tested at 1450° C. in air at an applied tensile stress of 69 MPa. These results indicate that the both the steady-state creep rate and total creep strain for a given test time were significantly reduced after treatment. It was determined that the composites remained un-cracked during the creep test so that the improvement in composite creep resistance was due primarily to an improvement in the creep resistance of the full CVI SiC matrix.

### Example 3

For this case, Sylramic-iBN/BN/SiC panels were fabricated with various intermediate fractions of CVI SiC matrix, ranging from about 20 vol % to 39 vol %. Half of each panel was kept in its as-fabricated condition, and the other half was treated in one atmosphere of argon at 1700° C. Based on prior silicon removal studies, the lowest CVI-SiC half-pan-is were treated for 1 hr. and the highest CVI-SiC half-panels for 20 hrs. Remaining matrix porosity in all the untreated and treated panel pieces was then filled as much as possible either by the melt infiltration of silicon near 1400° C. or by an initial slurry infiltration of SiC particulate followed by silicon melt-infiltration. The final panels were then machined into various sized specimens for thermal conductivity and creep measurements.

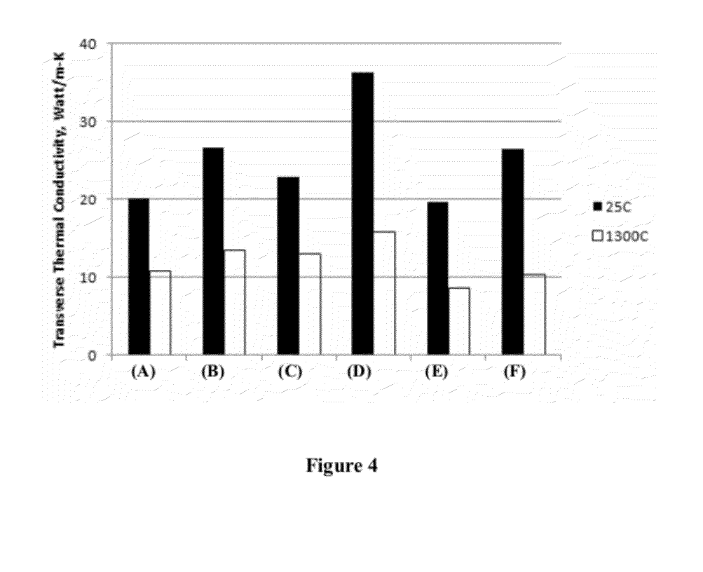

FIG. 4 shows the effect of treatment on the 25° C. and 1300° C. transverse thermal conductivity of Sylramic-iBN fiber-reinforced SiC/SiC composites with about 20, 28, and 39 vol % CVI SiC matrices whose remaining porosities were filled by silicon alone or by SiC particulate and silicon. By practice of this invention, improvement in transverse thermal conductivity was seen for all CVI SiC composite systems, with nearly 30 and 10% improvement in conductivity for the 39 vol %, system at 25° C. and 1300° C., respectively. Treatment also improved the axial thermal conductivity of these composites by about 80 and 40% at 25° C. and 1300° C., respectively.

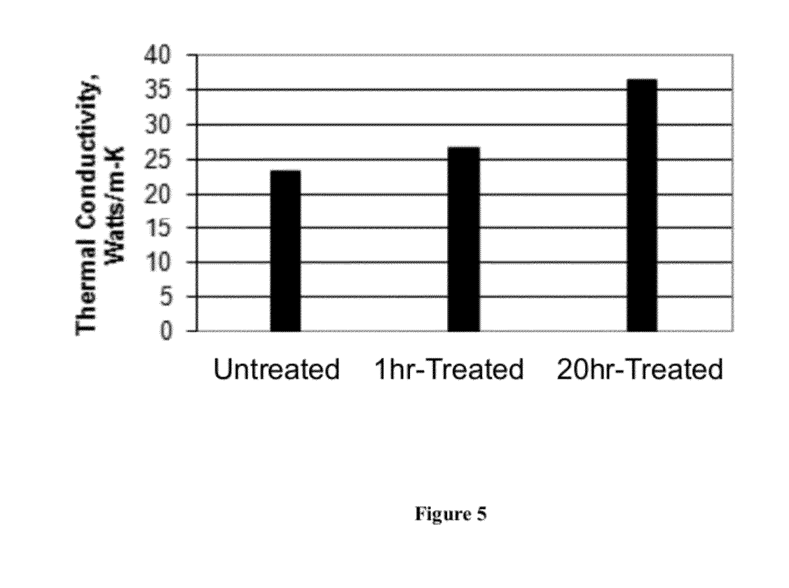

As described above, the treatment conditions for the SiC/SiC preforms or the CVI SiC/SiC composites had to be tailored depending on the volume fraction of the CVI SiC content in the composite and the stoichiometry of the CVI SiC as provided by a particular CMC vendor. FIG. 5 illustrates the effect of treatment hold-time on the room-temperature transverse thermal conductivity for a SiC/SiC composite containing about 39 vol % CVI SiC and remaining porosity filled by the melt infiltration of silicon. Thus initial experiments must be conducted to determine the treatment temperature and hold-time to obtain the optimum benefits of treatment on thermal conductivity and creep resistance without significantly degrading tensile strength of the composites.

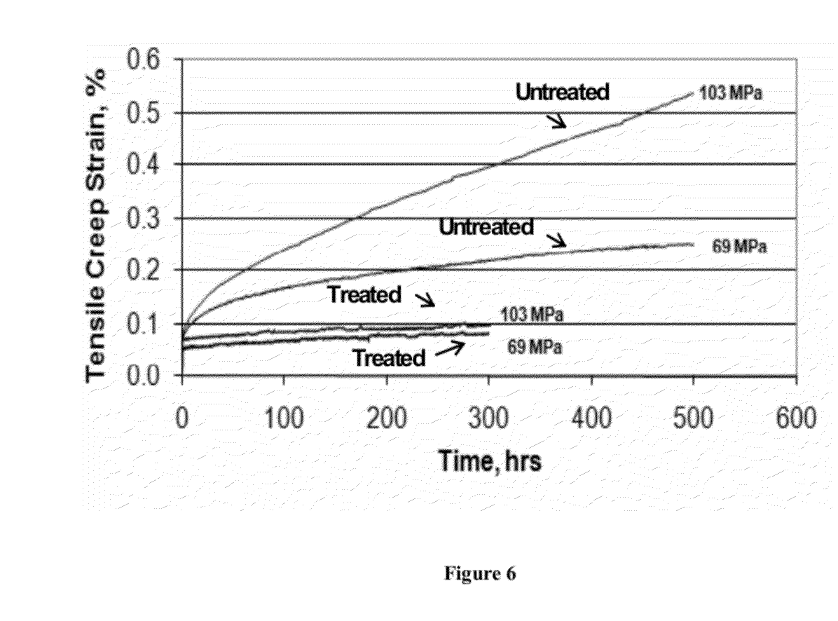

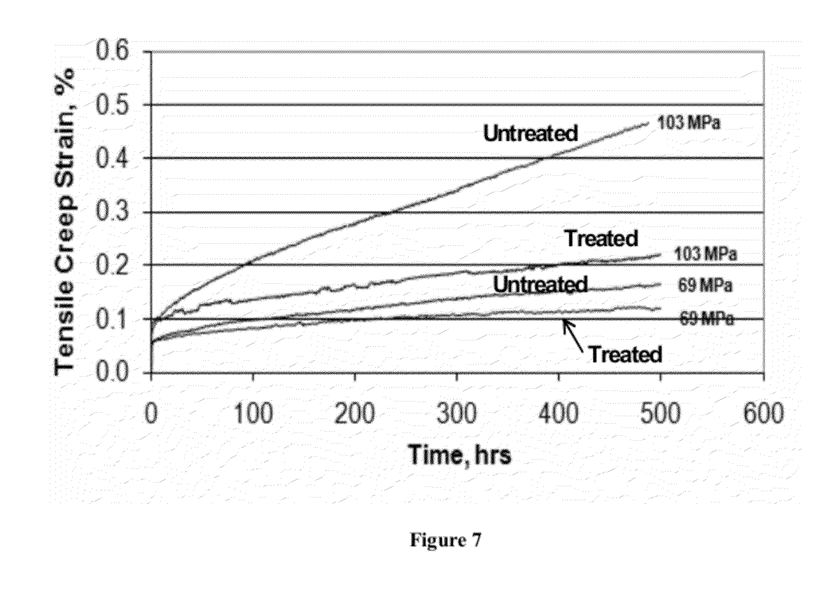

Advantages of this innovation for enhancing the creep resistance of SiC/SiC composites with 39 and 29 vol % CVI SiC are shown, respectively, in FIGS. 6 and 7 for creep tests performed at 1315° C. in air and at stress levels of 69 and 103 MPa. In these Figures, the untreated specimens consistently showed a significantly higher amount of total creep for a given time period compared to those heat-treated and tested under the same testing conditions. Comparison of the steady-state creep rates also indicated a significantly reduced effect for the treated SiC/SiC composites.

The advantage of using the highest possible CVI SiC matrix content for maximizing the creep resistance of the melt-infiltrated SiC/SiC composites can be seen by comparing FIGS. 6 and 7. This advantage is seen both for the untreated and treated panels, with the latter panels clearly showing the best behavior for a given matrix content. However, as shown by comparing FIGS. 2 and 4, the approach of using full CVI SiC has a detrimental effect on composite thermal conductivity, presumably due to the large amount of trapped. porosity. Thus for the hybrid CVI-MI SiC/SiC composites, the goal of optimized thermal conductivity and creep resistance with minimal loss in ultimate strength (see FIG. 1) appears best achieved with application of this invention to composites with CVI SiC matrix fractions of about 35 vol. %.

### Example 4

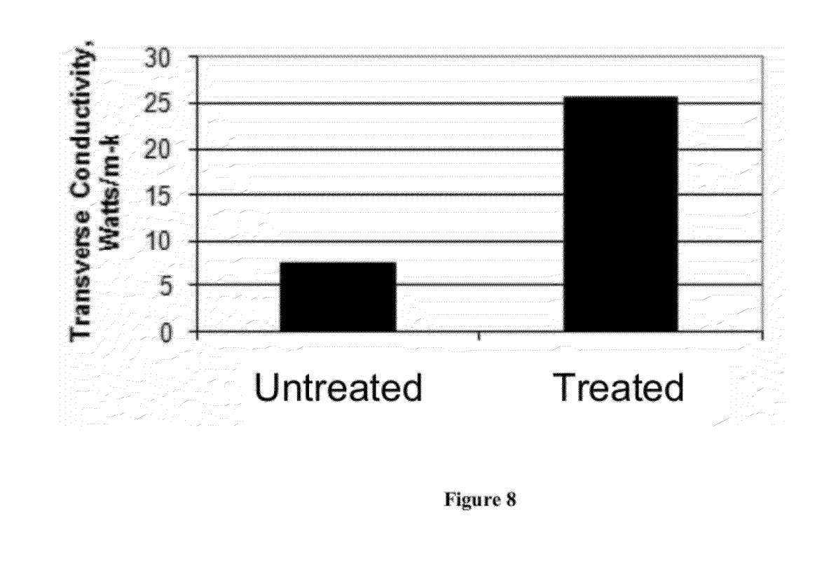

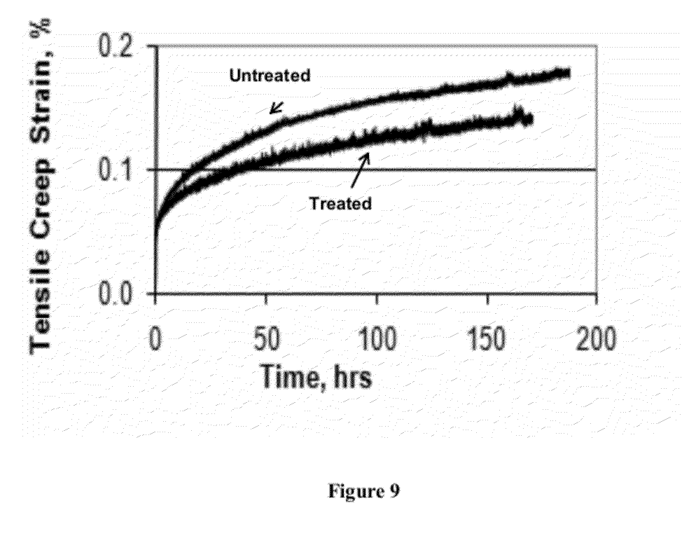

For this case, PIP processes rather than MI processes were employed to fill the open porosity in an as-received Sylramic-iBN/BN/SiC panel fabricated with about 35% volume fraction of CVI SiC matrix. A SiC yielding polymer was first infiltrated at room temperature and then the polymer-infiltrated panel was exposed to a high temperature (less than 1700° C.) to pyrolyze the polymer and leave a SiC char in the composite pores. This process was repeated multiple times until the remaining composite porosity was about 10%. Half of the panel was kept in its as-fabricated condition (CVI+PIP), and the other half was treated in one atmosphere of argon at 1800° C. for 1 hour. FIGS. 8 and 9 indicate that the treatment nearly doubled the room temperature transverse thermal conductivity and decreased the total creep strain and steady-state creep rate for the hybrid (CVI+PIP) composites. Because of the absence of silicon in the final matrix, the creep testing for the CVI+PIP composites could be conducted at a much higher temperature than that used for the CVI+Si composites. Also by comparing FIGS. 3 and 9, the creep resistance advantage of full CVI SiC over hybrid matrix approaches like CVI+PIP can again be seen.

### Example 5

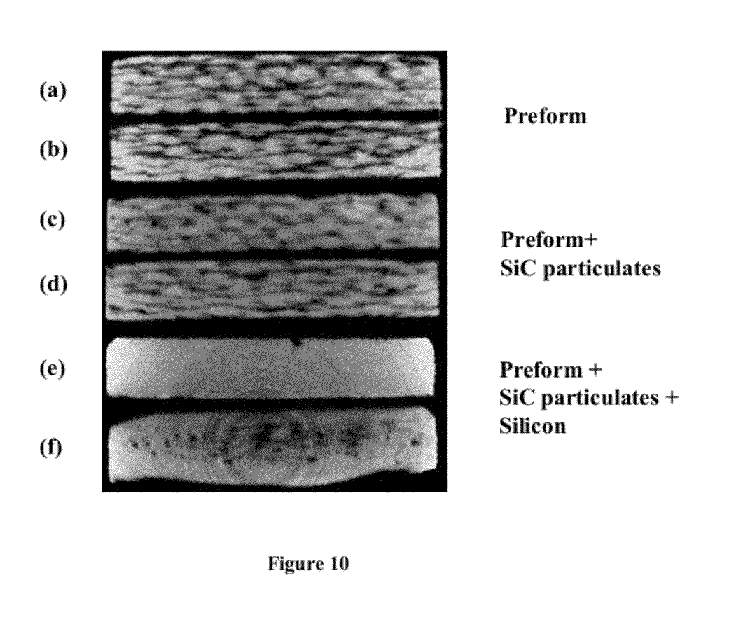

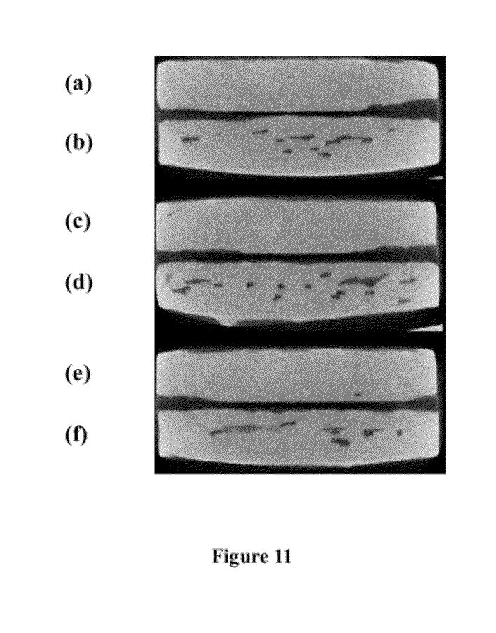

For this case Sylramic-iBN/BN/SiC preform panels were fabricated with about 20 and about 35 vol % CVI SiC matrix. Half of each panel was kept in its as-fabricated condition, and the other half was treated in one atmosphere of argon at 1700° C. Both pieces of panel containing about 20 vol % CVI SiC were first infiltrated with SiC particulate slurry and then with molten silicon. Whereas pieces of the panel containing about 35 vol % SiC matrix were infiltrated with silicon only. The panels before and after processing were first cut into tensile specimens and then each specimen was examined by computed tomography at three different locations of the specimens. FIGS. 10 and 11 shows that treated specimens always showed better matrix infiltration and fully dense matrix compared to untreated specimens. This beneficial effect can be attributed to formation of a carbon-rich surface on the external surfaces of the CVI SiC matrix which enhanced the wet-ability and infiltration characteristics of the molten silicon.

### Example 6

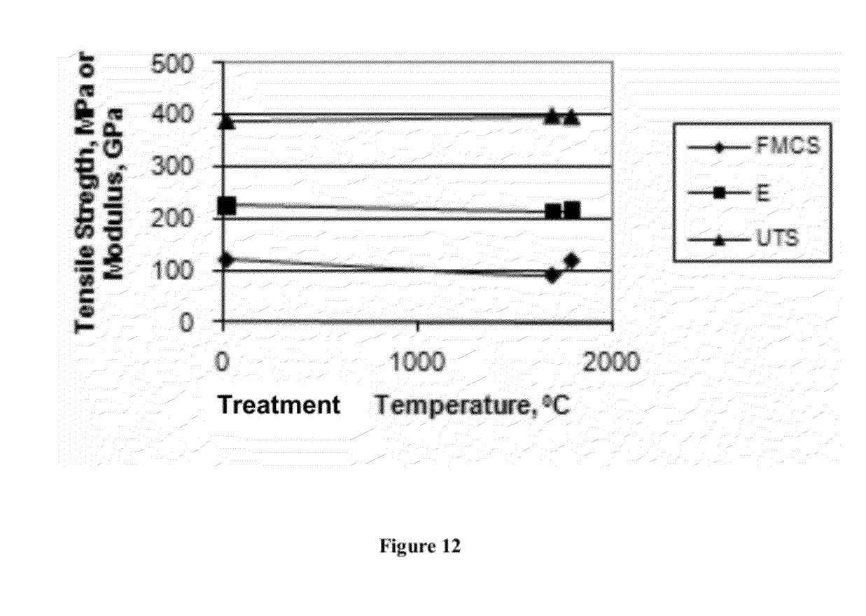

For this case, Sylramic-iBN/C/SiC panels were fabricated by a CMC vendor with a CVI carbon fiber coating and with the highest possible volume fraction of CVI SiC matrix. These panels were effectively full CVI SiC matrix composites with a matrix volume fraction of about 50%, a closed porosity of about 10%, and an open porosity of about 0%. The panel was machined into tensile specimens. The individual specimens were treated in one atmosphere of argon at 1700° C. and 1800° C. for 1 hour and then their tensile properties were measured at room temperature. The influence of treatment temperature on room temperature tensile properties is shown in FIG. 12. The data indicate essentially no loss in tensile properties after treatment.

### Example 7

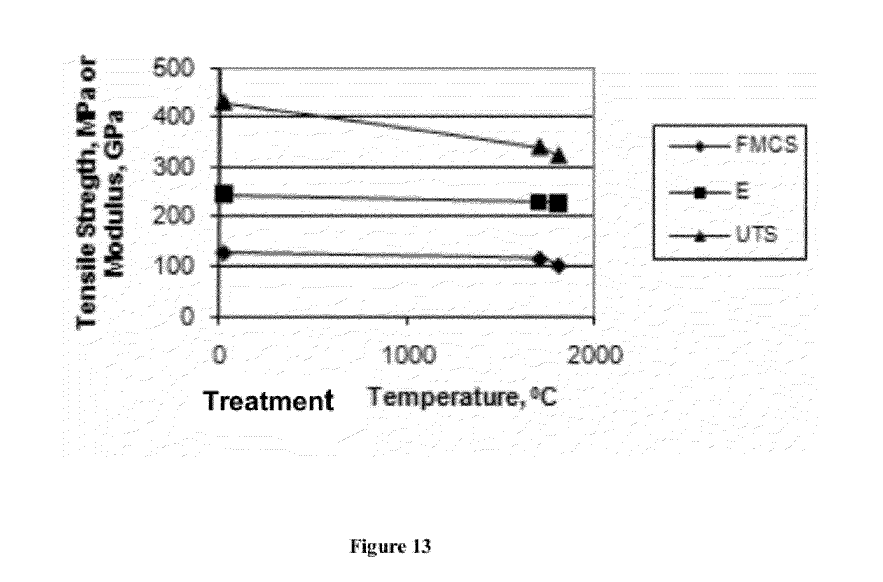

For this case, Sylramic-iBN/BN/C/SiC panels fabricated by a CMC vendor with the highest possible volume fraction of CVI SiC and with a CVI carbon layer on top of a CVI BN fiber coating. These panels were effectively full CVI SiC matrix composites with a matrix volume fraction of about 50%, a closed porosity of about 10%, and an open porosity of about 0%. The panel was machined into tensile specimens. The individual specimens were treated in one atmosphere of argon at 1700° C. and 1800° C. for 1 hour and then their tensile properties were measured at room temperature. The influence of treatment temperature on room temperature tensile properties is shown in FIG. 13. The data indicate no significant loss in first matrix cracking stress and modulus, but a loss in UTS in treated specimens when compared to the tensile properties of as-fabricated untreated specimens. This shows that further optimization of a dual layered fiber coating is needed to minimize silicon attack and loss in UTS after treatment of composites with high CVI SiC and free silicon content. In view of the foregoing, it is to be understood that numerous modifications and variations of the present invention may be implemented by those of skill in the art. The foregoing figures, discussion, and description are illustrative of some specific embodiments, but are not meant to be a limitation upon the practice thereof. For example, the present invention may suitably comprise, consist of, or consist essentially of, the elements claimed below. Thus, it is the following claims, including all equivalents, which define the scope of the invention.

We claim:

1. A method for improving the thermo-structural properties of a ceramic matrix composite material, the method comprising the steps of:
a. providing a ceramic matrix composite material that is comprised of (i) an architectural preform of high-strength reinforcing fibers, (ii) a thin interface coating on the fiber preform, and (iii) a ceramic-based matrix that was partially or fully infiltrated into the preform, where said reinforcing fibers were originally produced under process time-temperature conditions greater than those originally used for producing the fiber interface coating and ceramic-based matrix; and
b. treating said ceramic matrix composite material at (i) a process temperature for (ii) a process hold-time under (iii) a process gas at (iv) a process pressure and (v) a process flow rate.

2. The method of claim 1 wherein the thermal treatment improves the thermal conductivity of the original ceramic composite material with less than 10 percent loss in fiber tensile strength and less than 10 percent loss in composite tensile strength.

3. The method of claim 1 wherein the thermal treatment improves the creep resistance of the original ceramic composite material with less than 10 percent loss in fiber tensile strength and in composite tensile strength.

4. The method of claim 1, wherein the thermal treatment improves the thermal stability and thermal conductivity of the fiber interfacial coating by removing porosity in the coating.

5. The method of claim 1, wherein the ceramic matrix consists of a silicon carbide composition and the thermal treatment produces a thin carbon layer on the silicon-carbide surfaces with less than 10 percent loss in fiber and composite tensile strength

6. The method of claim 5, whereby a subsequent final fabrication of the composite matrix by infiltration of molten silicon or molten silicides or molten silicon alloys is enhanced, thereby reducing the porosity and permeability of the original ceramic matrix composite material.

7. The method of claim 1, wherein the fibers are continuous in length and have an average tensile strength that is greater than 2.5 GPa which degrades less than 10% under the treatment conditions.

8. The method of claim 1 wherein the reinforcing fibers have a silicon carbide or carbon composition and comprise at least twenty percent by volume of the original ceramic composite material.

9. The method of claim 1 wherein the chemical and physical characteristics of the fiber interfacial coating are such as to minimize chemical attack and strength degradation of the fiber during the original production of the ceramic-based matrix and during the treatment.

10. The method of claim 1, wherein the composition of the fiber interfacial coating consists of boron nitride, or carbon on top of boron nitride, or boron nitride doped with silicon, or silicon nitride on top of boron nitride, or a combination thereof.

11. The method of claim 1, wherein the ceramic matrix material is partially or fully formed by chemical vapor infiltration of silicon-carbide yielding gases, or is first partially formed by chemical vapor infiltration of silicon-carbide yielding gases followed by infiltration of silicon-carbide particulate or by polymer infiltration and pyrolysis of silicon-carbide yielding polymer, or a combination thereof.

12. The method of claim 11, wherein the silicon carbide matrix material formed by chemical vapor infiltration contains a free silicon content of less than 1 percent by volume.

13. The method of claim 11 wherein the ceramic matrix composite material is treated at a process temperature of at least 1600° C. for a process hold-time sufficient to remove free silicon and other defects that are contained in the ceramic matrix.

14. The method of claim 11, wherein the treatment temperature and hold-time conditions are sufficient to reduce the silicon to carbon ratio in the ceramic matrix to less than 1.005 atoms of silicon to one atom of carbon.

15. The methods of claim 3 wherein the ceramic composite material is subject to a thermal treatment in vacuum, or in a gaseous environment consisting of an inert gas, or high-purity nitrogen, or in a combination thereof at a pressure up to 40 atmospheres.

16. The method of claim 2 wherein the ceramic composite material is subject to a thermal treatment in vacuum, or in a high purity inert gas at a pressure up to 40 atmospheres.

17. The methods of claim 15 wherein the inert gas consists of high purity helium, neon, argon, xenon, krypton, radon, or a combination thereof.

18. The methods of claim 15 wherein the thermal treatment comprises a process temperature between 1600° C. and 1800° C. for a processing hold-time of up to 100 hours in vacuum or in an gaseous environment with a purity greater than 99% at a pressure less than 2 atmospheres and with a flow rate between zero and one cubic-foot/hr.

19. The method of claim 15 wherein the ceramic matrix composite material is treated at 1700° C. for a processing hold-time of at least one hour in a vacuum or in high-purity argon at a pressure of slightly greater than one atmosphere.

20. The method of claim 16 wherein the ceramic matrix composite material is treated at 1700° C. for a processing hold-time of at least one hour in a vacuum or in high-purity argon at a pressure of slightly greater than one atmosphere.
